(19) United States
(12) Patent Application Publication
(10) Pub. No.: US 2025/0015610 A1
(43) Pub. Date: Jan. 9, 2025

(54) SWITCHABLE PARALLEL CONFIGURATIONS FOR MODULAR BATTERY SYSTEM

(71) Applicant: GM GLOBAL TECHNOLOGY OPERATIONS LLC, Detroit, MI (US)

(72) Inventors: Andrew P. Oury, Troy, MI (US); Brendan M. Conlon, Rochester Hills, MI (US)

(73) Assignee: GM GLOBAL TECHNOLOGY OPERATIONS LLC, Detroit, MI (US)

(21) Appl. No.: 18/348,051

(22) Filed: Jul. 6, 2023

(51) Int. Cl. H02J 7/00; B60L 58/22

(52) U.S. Cl. CPC H02J 7/0024; B60L 58/22; H02J 7/0019; H02J 2310/48

(57) ABSTRACT

A modular battery system includes a battery pack with multiple battery modules electrically interconnected via a plurality of electrical cables. A plurality of switches selectively connects the multiple battery modules. A direct current (DC) charge connector is configured to electrically connect the battery pack to an off-board DC fast-charging station, via the plurality of electrical cables. The pack circuit is adapted to switch between a first configuration and a second configuration based on a respective position of the plurality of switches. A controller is configured to select the respective position of each of the plurality of switches to transition the pack circuit between the first configuration and the second configuration, in response to input signals indicative of a requested operating mode of the battery pack. The first configuration provides three parallel electrical pathways, and the second configuration provides two parallel electrical pathways.

### INTRODUCTION

The present disclosure relates generally to a modular battery system and a motor vehicle having the same. More specifically, the disclosure relates to a modular battery system that is switchable between parallel configurations. The use of mobile platforms employing a rechargeable energy source, both as an exclusive source of energy and a non-exclusive source of energy, has greatly increased over the last few years. A rechargeable energy storage device with battery packs may store and release electrochemical energy as needed during a given operating mode. The electrochemical energy may be employed for propulsion, heating or cooling a cabin compartment, powering vehicle accessories and other uses.

### SUMMARY

Disclosed herein is a modular battery system having a battery pack with multiple battery modules and a plurality of electrical cables. The multiple battery modules are electrically interconnected via the plurality of electrical cables in a pack circuit. The system includes a plurality of switches selectively connecting the multiple battery modules. The multiple battery modules are divided into a first group, a second group, a third group and a fourth group. A direct current (DC) charge connector is configured to electrically connect the battery pack to an off-board DC fast-charging station, via the plurality of electrical cables. The battery pack is selectively connectable to a propulsion output.

The pack circuit is adapted to switch between a first configuration and a second configuration based on a respective position of the plurality of switches. A controller is configured to select the respective position of each of the plurality of switches to transition the pack circuit between the first configuration and the second configuration, in response to input signals indicative of a requested operating mode of the battery pack. The respective battery cells in the pack circuit are arranged in a combination of series and parallel interconnections. The first configuration provides three parallel electrical pathways, and the second configuration provides two parallel electrical pathways. The parallel electrical pathways refer to individual ones of the respective battery cells arranged in parallel, or groups of the respective battery cells arranged in parallel.

The first configuration may represent a propulsion mode, and the second configuration may represent a charging mode. In one embodiment, the first configuration provides a propulsion power of about 400 volts and the second configuration provides a charging power of about 600 volts. The multiple battery modules may be divided into a first group, a second group, a third group and a fourth group. The first group includes two modules positioned at a negative end of the pack circuit, the fourth group including another two modules positioned at a positive end of the pack circuit. The second group and the third group respectively include a single module positioned in a middle of the pack circuit.

The plurality of switches may include a first load switch configured to electrically connect the pack circuit to a positive leg of the propulsion output, and a second load switch configured to electrically connect the pack circuit to a negative leg of the propulsion output. The plurality of switches may include a first charge switch configured to electrically connect the pack circuit to the positive leg of the DC charge connector, and a second charge switch configured to electrically connect the pack circuit to the negative leg of the DC charge connector.

In some embodiments, the first group includes one-third of respective battery cells in the pack circuit, the fourth group includes another one-third of the respective battery cells in the pack circuit, and the second group and the third group together include a remaining one-third of the respective battery cells of the pack circuit.

The plurality of switches may include a central switch configured to electrically connect, when in a respective closed position: a respective positive leg of the second group to the respective positive leg of the first group, and a respective negative leg of the fourth group to the respective positive leg of the first group. At least one of the plurality of switches may be an electro-mechanical contactor. At least one of the plurality of switches may be a solid-state switch and/or a diode.

The first configuration may be achieved when: the central switch is in the respective closed position; a first load switch and a second load switch electrically connect the pack circuit to the propulsion output; the respective negative leg of the second group is selectively connected to the propulsion output; and the respective positive leg of the third group is selectively connected to the propulsion output. The second configuration may be achieved when: the central switch is in a respective open position; a first charge switch and a second charge switch electrically connect the pack circuit to the DC charge connector; the respective positive leg of the first group is selectively connected to the respective negative leg of the second group; and the respective positive leg of the third group to the respective negative leg of the fourth group.

The plurality of switches may include a first two-way switch having two closed positions. In one of the two closed positions, the first two-way switch is configured to electrically connect the respective negative leg of the second group to the propulsion output. In another of the two closed positions, the first two-way switch is configured to electrically connect the respective positive leg of the first group to the respective negative leg of the second group.

The plurality of switches may include a second two-way switch having two closed positions. In one of the two closed positions, the second two-way switch is configured to electrically connect the respective positive leg of the third group to the propulsion output. In another of the two closed positions, the second two-way switch is configured to electrically connect the respective positive leg of the third group to the respective negative leg of the fourth group.

Disclosed herein is a motor vehicle having a battery pack with multiple battery modules and a plurality of electrical cables. The multiple battery modules are electrically interconnected via the plurality of electrical cables in a pack circuit. The battery pack is selectively connectable to a propulsion output for generating propulsion power for the vehicle. The battery pack includes direct current (DC) charge connector configured to electrically connect the battery pack to an off-board DC fast-charging station, via the plurality of electrical cables, the multiple battery modules being divided into a first group, a second group, a third group and a fourth group. The battery pack includes a plurality of switches selectively connecting the multiple battery modules, the pack circuit being adapted to switching between a first configuration and a second configuration based on a respective position of the plurality of switches. A controller is configured to select the respective position of each of the plurality of switches to transition the pack circuit between the first configuration and the second configuration, in response to input signals indicative of a requested operating mode of the battery pack. The first configuration provides three parallel electrical pathways, and the second configuration provides two parallel electrical pathways.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a modular battery system having multiple battery modules;

FIG. 2 is a schematic diagram of an example pack circuit employable in the system of FIG. 1, the pack circuit being in a first configuration; and

FIG. 3 is a schematic diagram of the pack circuit shown in FIG. 2, the pack circuit being in a second configuration.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

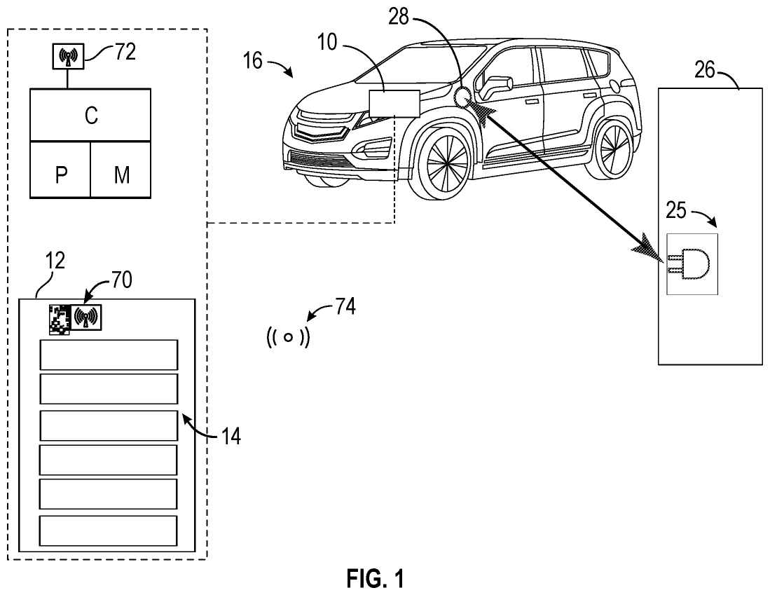

Referring to the drawings, wherein like reference numbers refer to like components, FIG. 1 schematically illustrates a modular battery system 10 having a battery pack 12 with multiple battery modules 14. Each of the modules 14 may include respective battery cells having different chemistries, including but not limited to, lithium-ion, lithium-iron, nickel metal hydride and lead acid batteries. It is understood that the number of battery cells in each module and the number of modules in the battery pack 12 may be varied based on the application at hand.

The modular battery system 10 may be part of a rechargeable energy storage device for powering a vehicle 16. The vehicle 16 may be partially electric or fully electric. The vehicle 16 may be a mobile platform, such as, but not limited to, a passenger vehicle, sport utility vehicle, light truck, heavy duty vehicle, ATV, minivan, bus, transit vehicle, bicycle, moving robot, farm implement (e.g., tractor), sports-related equipment (e.g., golf cart), boat, plane and train. It is to be understood that the vehicle 16 may take many different forms and have additional components.

Switchable battery circuits face limitations in achieving various configurations. For example, a circuit with a switchable configuration in a 2:1 ratio (with two parallel electrical pathways in one configuration and one parallel electrical pathway in another configuration) is not able to support a battery pack with 300 cells with a 3P100S configuration to switch to a higher voltage for charging. Here the number before the P is the number of parallel batteries in the battery pack 12 and the number before the S is the number of battery cells in series. This is because the integers in the ratio represent real cells which are indivisible. Hence, it is not a trivial matter to devise battery pack circuits with switchable configurations in a specific ratio for meeting various needs of component re-use, packaging, and voltage.

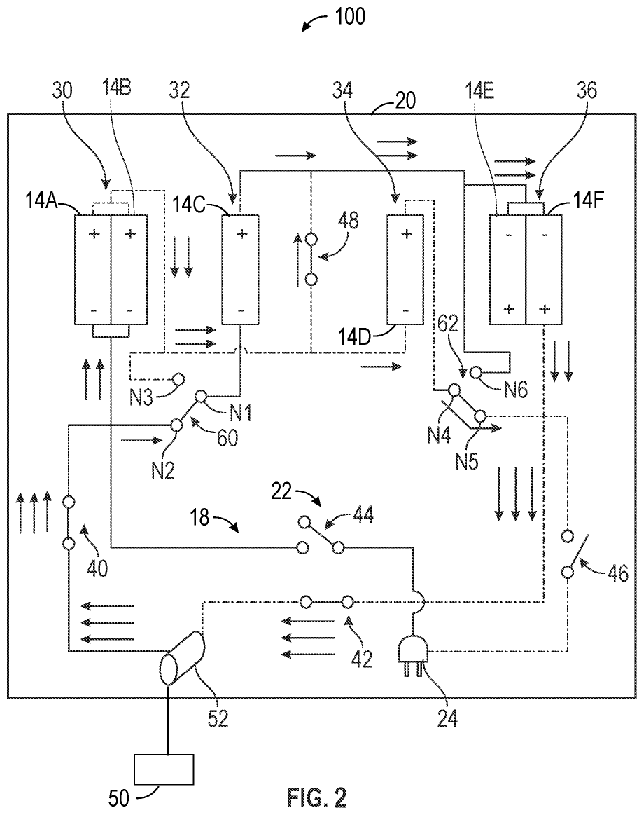

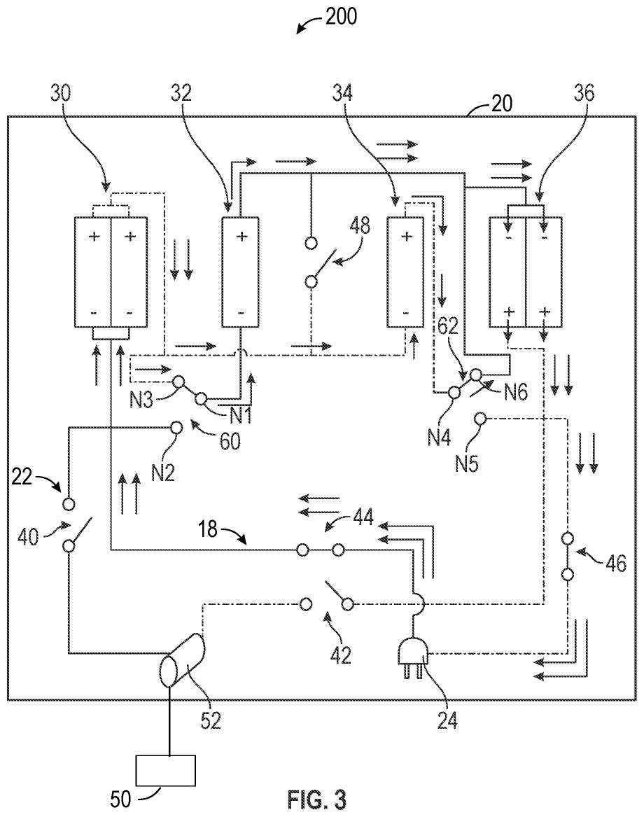

As described below, the battery pack 12 includes a specific set of modules, switches, and interconnects that allow the battery pack 12 to switch between a first configuration 100 and a second configuration 200, respectively shown in FIGS. 2-3. The first configuration 100 provides three parallel electrical pathways (3P mode), and the second configuration 200 provides two parallel electrical pathways (2P mode). The structure described below enables a ratio of 3:2, enabling a battery pack 12 with a 3P100S configuration to readily switch to a 2P150S configuration.

Referring to FIGS. 2-3, the multiple battery modules 14 are electrically interconnected via a plurality of electrical cables 18 in a pack circuit 20. The pack circuit 20 includes a plurality of switches 22 adapted to selectively connect the multiple battery modules 14. Referring to FIG. 1, the modular battery system 10 includes a controller C adapted to select the respective position of each of the plurality of switches 22 to transition the pack circuit 20 between the first configuration 100 and the second configuration 200, in response to input signals indicative of a requested operating mode of the battery pack 12.

Referring to FIG. 1, the controller C has at least one processor P and at least one memory M (or non-transitory, tangible computer readable storage medium) on which instructions are recorded for controlling operation of the plurality of switches 22. The memory M can store executable instruction sets, and the processor P can execute the instruction sets stored in the memory M. The modular battery system 10 avoids having to re-design motors and inverters by using the same circuit for various modes of operation.

Referring to FIGS. 2-3, the multiple battery modules 14 may be selectively connected to a direct current (DC) charge connector 24, via one of the plurality of electrical cables 18. Referring to FIG. 1, the vehicle 16 may undergo a direct current (DC) fast-charging operation in which the battery pack 12 is electrically connected to an off-board DC fast-charging station 26, via a vehicle charging port 28. The battery pack 12 connects to the charging port 28, which may be selectively coupled to the off-board DC fast-charging station 26 via further attachments, such as connector 25.

Referring to FIGS. 2-3, the multiple battery modules 14 are divided into a first group 30, a second group 32, a third group 34 and a fourth group 36. The first group 30 includes two modules 14A, 14B positioned at a (most) negative end of the pack circuit 20, labeled in FIG. 2. The fourth group 36 includes two modules 14E, 14F positioned at a (most) positive end of the pack circuit 20. The second group 32 and the third group 34 respectively include a single module 14C, 14D positioned in a middle of the pack circuit 20, labeled in FIG. 2.

The parallel electrical pathways refer to single or groups of n cells in parallel. The respective battery cells in the pack circuit 20 are arranged in a combination of series and parallel interconnections. The total number of cells in the circuit may be (S×P) arranged in an array such that the current divides equally between each cell and the voltage drop is applied equally across each of the battery cells. In the first configuration 100, the parallel count P is 3/2 and the series count S is 2/3 relative to the second configuration 200. The first group 30 and the fourth group 36 may be constructed with two series-connected modules or as two parallel-connected modules, each with the same number of cells. While the examples shown use the minimum number of cells in parallel, i.e. 1P and 2P, it is understood that larger packs may be made out of 2P and 4P modules with the same cells to attain higher energy capacity. Additionally, if the battery pack 12 was constructed using smaller cells (e.g., cylindrical), there may be a larger number of cells employed, e.g., ten cells in parallel for the second group 32 and third group 34; and twenty cells in parallel for the first group 30 and the fourth group 36.

In some embodiments, the first group 30 includes one-third of respective battery cells, and the fourth group 36 includes another one-third of the respective battery cells in the pack circuit 20. The second group 32 and the third group 34 together include a remaining one-third of the respective battery cells of the pack circuit 20.

The pack circuit 20 allows the battery pack 12 to switch between a first configuration 100 (3P mode with three cells in parallel in each group) to a second configuration 200 (2P mode with two cells in parallel in each group) enabling the battery pack 12 to generate an ideal voltage at various operating conditions. In the embodiment shown, the first configuration 100 represents a propulsion mode and the second configuration 200 represents a charging mode. In one example, the first configuration 100 provides a propulsion power of about 400 volts and the second configuration 200 provides a charging power of about 600 volts.

Referring to FIGS. 2-3, the plurality of switches 22 includes a first load switch 40, a second load switch 42, a first charge switch 44, a second charge switch 46 and a central switch 48. In one embodiment, the plurality of switches 22 includes at least one electro-mechanical contactor. The plurality of switches 22 may include at least one solid-state switch and/or a diode. It is understood that the plurality of switches 22 many have additional components and take different forms.

Referring to FIGS. 2-3, the first load switch 40 is configured to electrically connect the pack circuit 20 to a negative leg of a propulsion output 50 (via propulsion connector 52). The propulsion output 50 transmits the propulsion power to one or more electric machines for use by the vehicle 16. The second load switch 42 is configured to electrically connect the pack circuit 20 to a positive leg of the propulsion output 50. The first charge switch 44 is configured to electrically connect the pack circuit 20 to a negative leg of the DC charge connector 24. The second charge switch 46 is configured to electrically connect the pack circuit 20 to a positive leg of the DC charge connector 24.

The plurality of switches 22 may include a first two-way switch 60, and a second two-way switch 62. Alternatively, the first two-way switch 60 and the second two-way switch 62 may be respectively replaced by two one-way switches each. Referring to FIGS. 2-3, the first two-way switch 60 has a first node N1 that is alternately connectable to a second node N2 and a third node N3. The second two-way switch 62 has a node, referred to herein as fourth node N4, that is alternately connectable to a fifth node N5 and a sixth node N6. In other words, the first two-way switch 60 and second two-way switch 62 have two closed positions each.

Referring to FIG. 2, the first configuration 100 of the pack circuit 20 is achieved when the central switch 48 is in a respective closed position, the first node N1 of the first two-way switch 60 is electrically connected to the second node N2, and the fourth node N4 of the second two-way switch 62 is electrically connected to the fifth node N5. When the central switch 48 is closed, it electrically connects a respective positive leg of the second group 32 to the respective positive leg of the first group 30, and the respective negative leg of the fourth group 36 to the respective positive leg of the first group 30. Additionally, the first load switch 40 and the second load switch 42 are closed such that the propulsion output 50 is electrically connected to the pack circuit 20. In the first configuration 100, the first charge switch 44 and the second charge switch 46 are in their respective open positions.

In the first configuration 100 in FIG. 2, when the first node N1 of the first two-way switch 60 is electrically connected to the second node N2, the respective negative leg of the second group 32 is electrically connected to the propulsion output 50. When the fourth node N4 of the second two-way switch 62 is electrically connected to the fifth node N5, the respective positive leg of the third group 34 is electrically connected to the propulsion output 50.

Referring to FIG. 3, the second configuration 200 is achieved when the central switch 48 is in a respective open position, the first node N1 of the first two-way switch 60 is electrically connected to the third node N3, and the fourth node N4 of the second two-way switch 62 is electrically connected to the sixth node N6. In the second configuration 200 shown in FIG. 3, the battery pack 12 is being charged. Additionally, in the second configuration 200, the first load switch 40 and the second load switch 42 are in their respective open positions. The first charge switch 44 and the second charge switch 46 are closed, and electrically connect the pack circuit 20 to the negative leg and the positive leg, respectively, of the DC charge connector 24.

In the second configuration 200 in FIG. 3, when the first node N1 of the first two-way switch 60 is connected to the third node N3, the respective positive leg of the first group 30 is electrically connected to the respective negative leg of the second group 32. When the fourth node N4 of the second two-way switch 62 is connected to the sixth node N6, the respective positive leg of the third group 34 to the respective negative leg of the fourth group 36.

Referring to FIG. 1, the battery pack 12 may include a management unit 70 embedded with a microcircuit. The microcircuit may be an assembly of electronic components, with a core embodied by a microcontroller and including a wireless communication interface available to those skilled in the art. The microcircuit may include an associated memory, an associated processor and an integrated electronic controls unit, such as an application-specific integrated circuit (ASIC). Referring to FIG. 1, a pack communicator 72 may be linked or connected to the controller C, for example via a communication BUS, which may be a serial communication BUS in the form of a local area network. The controller C (through the pack communicator 72) may be adapted to interface wirelessly with the battery pack 12 (through the management unit 70), via a wireless network 74.

The wireless network 74 may be a short-range network or a long-range network. The wireless network 74 of FIG. 1 may be a Wireless Local Area Network (LAN) which links multiple devices using a wireless distribution method, a Wireless Metropolitan Area Networks (MAN) which connects several wireless LANs or a Wireless Wide Area Network (WAN) which covers large areas such as neighboring towns and cities. The wireless network 74 may be WIFI or a Bluetooth™ connection, defined as being a short-range radio technology (or wireless technology) aimed at simplifying communications among Internet devices and between devices and the Internet. Bluetooth™ is an open wireless technology standard for transmitting fixed and mobile electronic device data over short distances and creates personal networks operating within the 2.4 GHz band. Other types of connections may be employed.

In summary, the modular battery system 10 includes a specific set of modules, switches, and interconnects, that allow the battery pack 12 to efficiently switch between the first configuration 100 (3P mode) and the second configuration 200 (2P mode). In one embodiment, the modular battery system 10 is employed in an electric vehicle 16, generating a propulsion power of about 400 volts in the first configuration 100 and a charging voltage of about 600 volts in the second configuration 200. Being able to switch from a higher charging voltage (e.g., 600 volts) to a lower propulsion voltage (e.g., 400 volts) avoids the application of excess voltage to the propulsion components, relative to a non-switched 600 volts system. Alternately, it avoids passing excessive current through the charge port/connector for equivalent power or charging at reduced power for the same current, relative to a non-switched 400 volts system.

The controller C of FIG. 1 may be an integral portion of, or a separate module operatively connected to, other controllers of the vehicle 16. The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database energy system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A modular battery system comprising:
a battery pack having multiple battery modules and a plurality of electrical cables, the multiple battery modules being electrically interconnected via the plurality of electrical cables in a pack circuit, the multiple battery modules being divided into a first group, a second group, a third group and a fourth group;
a direct current (DC) charge connector configured to electrically connect the battery pack to an off-board DC fast-charging station, via the plurality of electrical cables, the battery pack being selectively connectable to a propulsion output;
a plurality of switches selectively connecting the multiple battery modules, the pack circuit being adapted to switching between a first configuration and a second configuration based on a respective position of the plurality of switches;
a controller having a processor and tangible, non-transitory memory on which instructions are recorded, the controller being adapted to select the respective position of the plurality of switches to transition the pack circuit between the first configuration and the second configuration, in response to input signals indicative of a requested operating mode of the battery pack;
wherein respective battery cells in the pack circuit are arranged in a combination of series and parallel interconnections; and
wherein the first configuration provides three parallel electrical pathways, and the second configuration provides two parallel electrical pathways, the parallel electrical pathways referring to individual ones of the respective battery cells arranged in parallel, or groups of the respective battery cells arranged in parallel.

2. The system of claim 1, wherein the first configuration represents a propulsion mode, and the second configuration represents a charging mode.

3. The system of claim 1, wherein the first configuration provides a propulsion power of about 400 volts and the second configuration provides a charging power of about 600 volts.

4. The system of claim 1, wherein the plurality of switches includes:
a first load switch configured to electrically connect the pack circuit to a positive leg of the propulsion output;
a second load switch configured to electrically connect the pack circuit to a negative leg of the propulsion output;
a first charge switch configured to electrically connect the pack circuit to the positive leg of the DC charge connector; and
a second charge switch configured to electrically connect the pack circuit to the negative leg of the DC charge connector.

5. The system of claim 1, wherein:
the first group includes two modules positioned at a negative end of the pack circuit, the fourth group including another two modules positioned at a positive end of the pack circuit; and
the second group and the third group respectively include a single module positioned in a middle of the pack circuit.

6. The system of claim 5, wherein:
the first group includes one-third of respective battery cells in the pack circuit;
the fourth group includes another one-third of the respective battery cells in the pack circuit; and
the second group and the third group together include a remaining one-third of the respective battery cells of the pack circuit.

7. The system of claim 5, wherein the plurality of switches includes a central switch configured to electrically connect, when in a respective closed position:
a respective positive leg of the second group to the respective positive leg of the first group; and
a respective negative leg of the fourth group to the respective positive leg of the first group.

8. The system of claim 7, wherein the first configuration is achieved when:
the central switch is in the respective closed position;
a first load switch and a second load switch electrically connect the pack circuit to the propulsion output;
the respective negative leg of the second group is selectively connected to the propulsion output; and
the respective positive leg of the third group is selectively connected to the propulsion output.

9. The system of claim 7, wherein the second configuration is achieved when:
the central switch is in a respective open position;
a first charge switch and a second charge switch electrically connect the pack circuit to the DC charge connector;
the respective positive leg of the first group is selectively connected to the respective negative leg of the second group; and
the respective positive leg of the third group to the respective negative leg of the fourth group.

10. The system of claim 7, wherein:
the plurality of switches includes a first two-way switch having two closed positions;
in one of the two closed positions, the first two-way switch is configured to electrically connect the respective negative leg of the second group to the propulsion output; and
in another of the two closed positions, the first two-way switch is configured to electrically connect the respective positive leg of the first group to the respective negative leg of the second group.

11. The system of claim 7, wherein:
the plurality of switches includes a second two-way switch having two closed positions;
in one of the two closed positions, the second two-way switch is configured to electrically connect the respective positive leg of the third group to the propulsion output; and
in another of the two closed positions, the second two-way switch is configured to electrically connect the respective positive leg of the third group to the respective negative leg of the fourth group.

12. The system of claim 1, wherein at least one of the plurality of switches is an electro-mechanical contactor.

13. The system of claim 1, wherein at least one of the plurality of switches includes a solid-state switch and/or a diode.

14. A motor vehicle comprising:
a battery pack having multiple battery modules and a plurality of electrical cables, the multiple battery modules being electrically interconnected via the plurality of electrical cables in a pack circuit, the battery pack being selectively connectable to a propulsion output for generating propulsion power for the vehicle;
wherein the battery pack includes:
a direct current (DC) charge connector configured to electrically connect the battery pack to an off-board DC fast-charging station, via the plurality of electrical cables, the multiple battery modules being divided into a first group, a second group, a third group and a fourth group;
a plurality of switches selectively connecting the multiple battery modules, the pack circuit being adapted to switching between a first configuration and a second configuration based on a respective position of the plurality of switches;
a controller configured to select the respective position of each of the plurality of switches to transition the pack circuit between the first configuration and the second configuration, in response to input signals indicative of a requested operating mode of the battery pack; and
wherein the respective battery cells in the pack circuit are arranged in a combination of series and parallel interconnections;
wherein the first configuration provides three parallel electrical pathways, and the second configuration provides two parallel electrical pathways, the parallel electrical pathways referring to individual ones of the respective battery cells arranged in parallel, or groups of the respective battery cells arranged in parallel.

15. The vehicle of claim 14, wherein:
the first group includes two modules positioned at a negative end of the pack circuit, the fourth group including two modules positioned at a positive end of the pack circuit; and
the second group and the third group respectively include a single module positioned in a middle of the pack circuit.

16. The vehicle of claim 14, wherein:
the first group includes one-third of respective battery cells in the pack circuit;
the fourth group includes another one-third of the respective battery cells in the pack circuit; and
the second group and the third group together include a remaining one-third of the respective battery cells of the pack circuit.

17. The vehicle of claim 14, wherein the plurality of switches includes a central switch configured to electrically connect, when in a respective closed position:
a respective positive leg of the second group to the respective positive leg of the first group; and
a respective negative leg of the fourth group to the respective positive leg of the first group.

18. The vehicle of claim 17, wherein the first configuration is achieved when:
the central switch is in the respective closed position;
a first load switch and a second load switch electrically connect the pack circuit to the propulsion output;
the respective negative leg of the second group is selectively connected to the propulsion output; and
the respective positive leg of the third group is selectively connected to the propulsion output.

19. The vehicle of claim 17, wherein the second configuration is achieved when:
the central switch is in a respective open position;
a first charge switch and a second charge switch electrically connect the pack circuit to the DC charge connector;
the respective positive leg of the first group is selectively connected to the respective negative leg of the second group; and
the respective positive leg of the third group to the respective negative leg of the fourth group.

20. A modular battery system comprising:
a battery pack having multiple battery modules and a plurality of electrical cables, the multiple battery modules being electrically interconnected via the plurality of electrical cables in a pack circuit, the multiple battery modules being divided into a first group, a second group, a third group and a fourth group;
a direct current (DC) charge connector configured to electrically connect the battery pack to an off-board DC fast-charging station, via the plurality of electrical cables, the battery pack being selectively connectable to a propulsion output;
a plurality of switches selectively connecting the multiple battery modules, the pack circuit being adapted to switching between a first configuration and a second configuration based on a respective position of the plurality of switches, the plurality of switches including a central switch;
a controller having a processor and tangible, non-transitory memory on which instructions are recorded, the controller being adapted to select the respective position of the plurality of switches to transition the pack circuit between the first configuration and the second configuration, in response to input signals indicative of a requested operating mode of the battery pack;
wherein respective battery cells in the pack circuit are arranged in a combination of series and parallel interconnections;
wherein the first configuration provides three parallel electrical pathways, and the second configuration provides two parallel electrical pathways, the parallel electrical pathways referring to individual ones of the respective battery cells arranged in parallel, or groups of the respective battery cells arranged in parallel;
wherein the first configuration is achieved when the central switch is in a respective closed position, a respective positive leg of the first group is selectively connected to a respective negative leg of the second group, and the respective positive leg of the third group to the respective negative leg of the fourth group; and
wherein the second configuration is achieved when the central switch is in a respective open position, the respective negative leg of the second group is selectively connected to the propulsion output, and the respective positive leg of the third group is selectively connected to the propulsion output.
